(19) United States
(12) Patent Application Publication
(10) Pub. No.: US 2017/0263146 A1
(43) Pub. Date: Sep. 14, 2017

(54) METHOD AND SYSTEM FOR BUILDING AND SCORING MOTOR SKILLS TESTS

(71) Applicant: Varun Aggarwal, Gurgaon (IN)

(72) Inventors: Varun AGGARWAL, Gurgaon (IN); Bhanu Pratap SINGH, Gurgaon (IN); Vinay SHASHIDHAR, Gurgaon (IN)

(21) Appl. No.: 15/068,155

(22) Filed: Mar. 11, 2016

(51) Int. Cl. G09B 19/00; G09B 5/02

(52) U.S. Cl. CPC G09B 19/003; G09B 5/02

(57) ABSTRACT

A method and system for measuring traits associated with motor skills of a user, and providing a score based on the traits is provided. The method is implemented on a non-transitory computer readable medium is provided. The method includes generating a predictive model comprising a benchmark to score each of the traits representative of motor skills. The method includes configuring test scenarios delivered on a touch based user interface having a communication interface with a processing device. The method includes measuring the traits based on user activity with the test scenarios, comparing the measurements with the corresponding measurements in the predictive model, generating at least one of, one or more scores, and feedback analytics for the traits based on the comparison; and reporting the one or more scores to at least one of the touch based user interface and an external device.

### FIELD OF THE INVENTION AND USE OF INVENTION

The invention relates generally to the field of online evaluation, and more specifically to a method and system for building and scoring motor skills tests to test motor skills of a user, useful in different industrial environments that require skilled work force.

### PRIOR ART AND PROBLEM TO BE SOLVED

There are many work environments which require different motor skills of the workers, namely, machine operators, technicians, jewelry manufacturer, healthcare professionals, craftsman, vocational trainees etc.

Presently, in order to both train and select human resources in these areas, usually some real world tasks are provided and the results are evaluated by either a comparison with a standard task in terms of time to complete and quality of the result, or is done based on the feedback of evaluation from a more skilled person or an expert in that field. These methods of testing/training are largely subjective, and always have challenge of availability of external human resource(s) for evaluation. While for smaller operations, these techniques can be sufficient, however, in the industrial sector, where large number of work force are employed, the present methods of evaluation pose a challenge.

For example, the measure of finger dexterity at present is done via assessor based established tests. These tests are prone to human error while measuring the time for the task. Also assessment of the pinch motion is a complex task when done using the naked eyes. The tests are neither automated nor normalized.

With new tools and machinery, and changing technology, these work environments are also posed with new challenges, of continuing to evolve the skills of the workers to handle the new technology, while keeping intact the core skills needed for the job. For example, in many industrial environments, the use of alarm buttons that was provided as a physical button that could be pressed with a thumb or a finger, is evolving to selecting an icon on a touch interface of a device. Similarly in the field of healthcare, care givers such as nurses or operators for medical apparatus, are now equipped with technology in the form of hand-held devices for recording and communicating a patient condition. Several of these devices require the care giver to select appropriate options to start, operate, and close the devices. The manner of interaction with these devices is undergoing a phenomenal change with the advent of touch based interfaces on these devices. Similarly, all other industries are going through an evolution stage for their equipment and the way operators interact for specific actions required for smooth functioning of the industrial processes.

### SUMMARY OF THE INVENTION

A method for measuring multiple traits associated with motor skills of a user, and providing a score based on the plurality of traits is provided. The method is implemented on a non-transitory computer readable medium. The method includes steps for generating a predictive model that includes a benchmark to score each of the traits, where the traits include one or more of finger dexterity, speed of execution, finger and thumb co-ordination, wrist rotation, hand-eye co-ordination, hand steadiness, reaction time, accuracy of action, and coordination between two arms to accomplish different tasks from each hand.

The method includes configuring a plurality of test scenarios delivered on a touch based user interface having a communication interface with a processing device. The method includes measuring one or more of the plurality of traits based on user activity with the test scenarios, where the user activity comprises at least one of movement of at least one finger along a predefined pattern in one or more trajectories, simultaneous movement of at least one finger and thumb, and movement of at least one finger when thumb is pivoted.

The method includes comparing the measurements with the corresponding measurements in the predictive model; generating at least one of, one or more scores, and feedback analytics for the one or more plurality of traits based on the comparison; and reporting the one or more scores to at least one of the touch based user interface and an external device.

A system for measuring a plurality of traits associated with motor skills of a user, and providing a score based on the plurality of traits is provided in another embodiment of the invention. The system is implemented using a non-transitory computer readable medium and includes a predictive model comprising a benchmark to score each of the plurality of traits, wherein the plurality of traits comprise at least one of finger dexterity, speed of execution, finger and thumb co-ordination, wrist rotation, hand-eye co-ordination, hand steadiness, reaction time, accuracy of action. The system also includes a test module having different test scenarios to test one or more of the plurality of traits. The system includes a touch based user interface for providing the test scenarios for user activity, wherein the user activity comprises at least one of movement of at least one finger along a predefined pattern in one or more trajectories, simultaneous movement of at least one finger and thumb, and movement of at least one finger when thumb is pivoted.

The system includes a processing module for receiving data representative of the user activity, for measuring one or more of the plurality of traits based on the user activity with the test scenarios, for comparing the measurements with the corresponding measurements in the predictive model, and for generating at least one of, one or more scores, and feedback analytics for the one or more plurality of traits based on the comparison; and a reporting module to receive and communicate at least one of, one or more scores, and feedback analytics for the one or more plurality of traits to at least one of the touch based user interface and an external device.

### DRAWINGS

These and other features, aspects, and advantages of the present invention will become better understood when the following detailed description is read with reference to the accompanying drawings in which like reference numerals represent corresponding parts throughout the drawings, wherein:

FIG. 1 is a flowchart representation of exemplary steps of the method for measuring a plurality of traits associated with motor skills of a user, and providing a score based on the plurality of traits, wherein the method is implemented on a non-transitory computer readable medium;

FIG. 2 is a diagrammatic representation of an exemplary system based on the method of the invention that is implemented using a non-transitory computer readable and storage medium;

FIG. 3 is a diagrammatic representation of a test scenario where the user is required is to change the size of the outer circle and fit it inside the inner circle;

FIG. 4 is a diagrammatic representation of a test scenario where the user has to precisely move his/her fingers to resize the outer circle inside the two inner circles.

FIG. 5 is a diagrammatic representation of a test scenario where the user can place thumb of the dominant hand on a particular position and use the same hand to trace inside an arc;

FIG. 6 is a diagrammatic representation of a test scenario where the user has to select the fire sign;

FIG. 7 and FIG. 8 are the diagrammatic representation of test scenarios where the user has to trace inside the given patterns; and

FIG. 9 and FIG. 10 are diagrammatic representations of test scenarios where the user has to roll the ball inside the circle.

### DETAILED DESCRIPTION OF THE INVENTION

As used herein and in the claims, the singular forms “a,” “an,” and “the” include the plural reference unless the context clearly indicates otherwise.

A “user” referred herein is a person undertaking one or more tests that are used to evaluate motor skills of the user. The user can be a candidate for a job in a particular work environment that requires the motor skills. The user can be an operator of a device used in an industrial setting for manufacturing goods. The user can be an operator in a service industry, such as a medical service, disaster management service, service division of an organization, etc.

One or more “traits” or a plurality of “traits” as referred herein correspond to motor skills related traits such as finger dexterity, speed of execution of task that involves hand (or any part of the hand including wrist, fingers, thumb)-eye co-ordination, finger and thumb co-ordination, wrist rotation, hand-eye co-ordination, hand steadiness, reaction time, accuracy of action, and other such trait related to motor skills of a person.

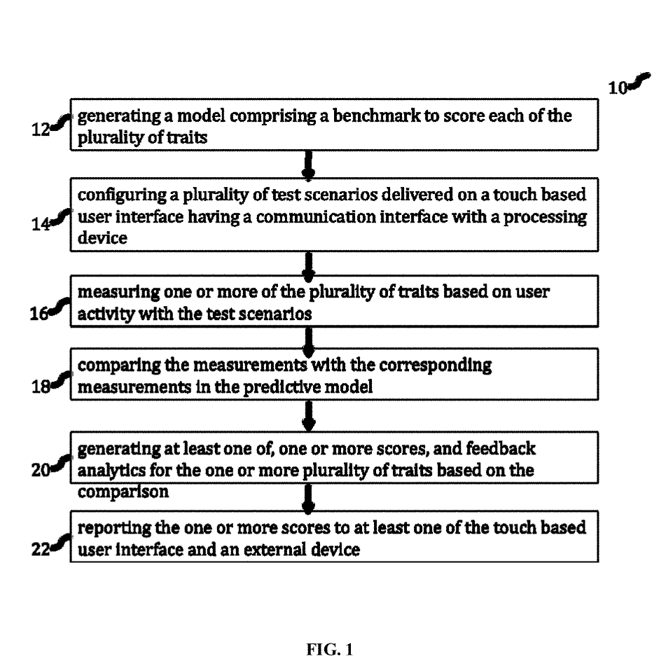

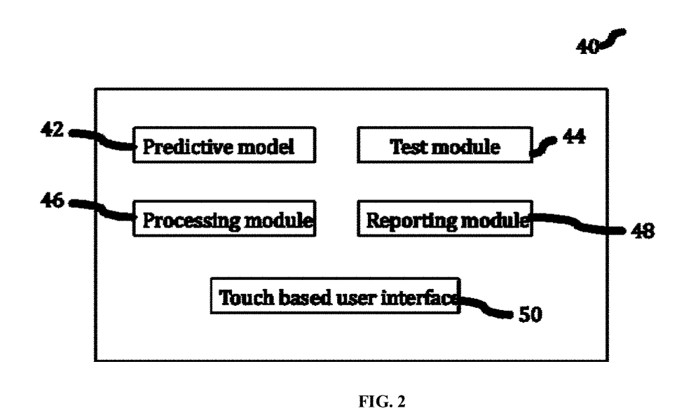

The invention herein provides a method shown in flowchart 10 of FIG. 1 for measuring different traits associated with motor skills of a user via a touch based user interface of a communication device, and also providing a score based on these traits. The touch based user interface may also be an accelerator based user interface. The method is implemented on a non-transitory computer readable medium.

The method includes a step 12 for generating a predictive model that includes a benchmark to score each of the traits. The predictive model for benchmarking, includes the measurements obtained from skilled user performance in real tasks such as screwing and unscrewing a screw net assembly on a metallic plate with holes, folding a piece of paper, picking fine and gross objects, flipping cards, screwing-unscrewing a screw-nut-washer assembly etc and other real world tasks that the user is required to have skills for in the particular work environment.

The real task scores provide scores on standard competencies such as finger dexterity, manual dexterity, wrist finger speed, etc. The predictive models are made for scoring each of these competencies using the real task scores. The predictive model, also uses regression techniques, other machine learning or expert methods to develop scoring criterion as benchmarks. The model is a standardized model, where operating parameters such as sensitivity, pressure, weight, accelerometer reading etc. for interaction with the touch/accelerator based interface, are accounted for, to ensure that meaning of the score doesn't change under different circumstances.

The method further includes configuring different test scenarios as shown at step 14 delivered on a touch based user interface having a communication interface with a processing device. The test scenarios include pre-defined patterns, pre-defined shapes, test instructions, and demonstration samples. Demonstration samples may be provided as video images, as well as may include some trial samples that the user can use before the start of the test. The test scenario, in one implementation includes a placeholder position for at least one of a thumb or at least one finger. This is to ensure authenticity of the user, and to ensure test is being properly undertaken. Some exemplary test scenarios include, drawing/tracing particular shapes, clicking objects appearing on the screen, doing different finger movements to complete tasks such as resizing an object, doing hand movements to tilt the tabs in different directions to accomplish a task.

The user activity includes at least one of movement on the touch based user interface, of at least one finger along a predefined pattern in one or more trajectories, simultaneous movement of at least one finger and thumb, and movement of at least one finger when thumb is pivoted. In one test example, the trajectory is along an arc of a circle. In another implementation, the trajectory is a path to be traced within a tunnel shape. The user activity in one example simulates the pinch action of the hand (test scenario is built to capture pinch action). The measurements includes in the pinch test scenario, for example, speed of simultaneously bringing the thumb and a finger together and accuracy with which the user can simultaneously bring the thumb and a finger at a given location. These motor movements are used in a number of job tasks such as grasping and squeezing objects. This skill is a part of the finger dexterity ability.

The method further includes a step 16 for measuring the traits based on user activity with the test scenarios. The measurement in one exemplary implementation, commences with the start of movement of user activity on the touch based user interface. In another implementation, the measurement commences by touching a “start” icon on the touch based user interface. Other representations to initiate the test and recording of measurement may also be used. The measurements include position co-ordinates for at least one of a finger and a thumb, and a time stamp for the position co-ordinates. Other direct measurement to record speed may also be included. The touch interface measures and records all the data required for scoring. For example, the interface logs the X and Y co-ordinates of the touch points of both the fingers and time stamps for all the touch points. The candidate is then scored on the basis of the logged data.

The method further includes a step 18 for comparing the measurements with the corresponding measurements of the traits in the predictive model. The method includes a step 20 for generating at least one of, one or more scores, and feedback analytics for the different traits based on the comparison. Both individual scores of each trait and a cumulative score for all the traits i.e. a cumulative motors skills score can be provided.

The method then includes a step 22 for reporting the one or more scores and feedback analytics to at least one of the touch based user interface and an external device. In one embodiment, the scores can be representative of the accuracy and speed for each skill while performing the task. In another embodiment, the scores map to a standard globally accepted taxonomy of skills, such as that from Onet Competencies map. In one exemplary implementation, the one or more scores are communicated to a communication device as input data for a job fitment determination that is provided through a processor based system and method. The predictive model also provides a predictive motor skill score for the user, which correlates a job specific motor skill requirement data with one or more of scores generated by measured traits. The predictive motor skill scores in exemplary embodiment are based on time for completion of desired task in the test scenario (the number of times candidate was able to spot the image of fire and click on the image in a given time), number of times the user input moved out of the desired task in the test scenario (e.g. hand moved out of the maze while tracing), etc. Accordingly the candidate's score in different competencies is also predicted with different set of features.

The feedback analytics based on the scores, may include online feedback communicated to the test taker (user) via a communication device, regarding his/her job fitment, and also suggesting necessary corrective action, if applicable, to help the test taker improve his/her score in the next attempt thus increasing the chances of getting a job based on these scores. In one embodiment, the test-taker gets on the fly feedback on how he/she is doing the tasks, his/her mistakes, etc. The feedback is generated by using the comparison of the scores with the measurements in the predictive model.

In another aspect, the invention provides a system 40 for measuring different traits associated with motor skills of a user, and providing a score based on these traits, where the system is implemented using a non-transitory computer readable medium. Some aspects of the system are also implemented on a computer storage medium. The system comprises a predictive model 42 as mentioned herein above, to provide a benchmark to score each of the traits referred herein above.

The system comprises a test module 44 with different test scenarios to test one or more of the traits. A touch based user interface is used for providing the test scenarios for user activity, where the user activity comprises at least one of movement of at least one finger along a predefined pattern in one or more trajectories, simultaneous movement of at least one finger and thumb, and movement of at least one finger when thumb is pivoted.

The system includes a processing module 46 for receiving data representative of the user activity, for measuring one or more of the plurality of traits based on the user activity with the test scenarios, for comparing the measurements with the corresponding measurements in the predictive model, and for generating at least one of, one or more scores, and feedback analytics for the one or more plurality of traits based on the comparison.

The system also includes a reporting module 48 to receive and communicate at least one of, one or more scores, and feedback analytics for the one or more plurality of traits to at least one of the touch based user interface and an external device.

It would be appreciated by those skilled in the art that the system mentioned herein, will have some of the modules such as but not limited to, predictive model, the test module, the processing module, and the reporting module that are configured on a server or a dedicated computing device. The server or the dedicated computing device may be a remote server. A downloadable application is configured in one application, that can be down loaded on a touch based communicating device such as a computer work station, a personal computer, a laptap, a tablet device, a mobile phone. The application can access remotely the test scenarios from the test module, and the user activity is communicated back to the processing module executed on a remote server.

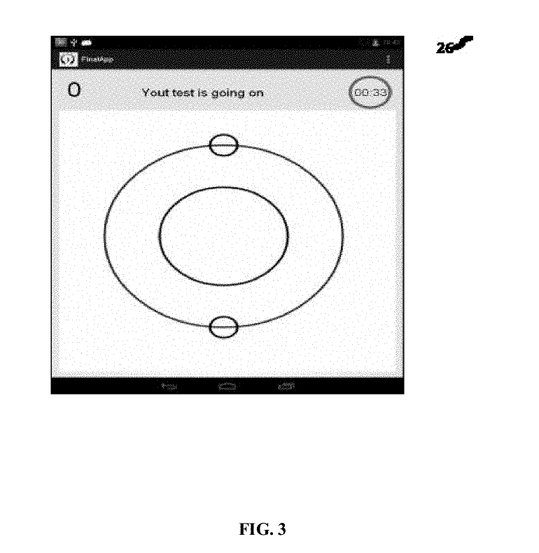

Some exemplary test scenarios are shown in FIG. 3-10 and include:

A “Fit” test scenario, where an inner circle which is the target (FIG. 3), and an outer circle are displayed on the touch interface. The user is required is to change the size of the outer circle and fit it inside the inner circle. On the outer circle two small markers on the perimeter, opposite to each other, are displayed, where the user has to put his/her fingers to change the size of the outer circle. Once the test starts, the user has to fit as many circles as possible. The size of the inner circle is varied to control for the difficulty of the test. The measurements include the speed trait of the finger dexterity.

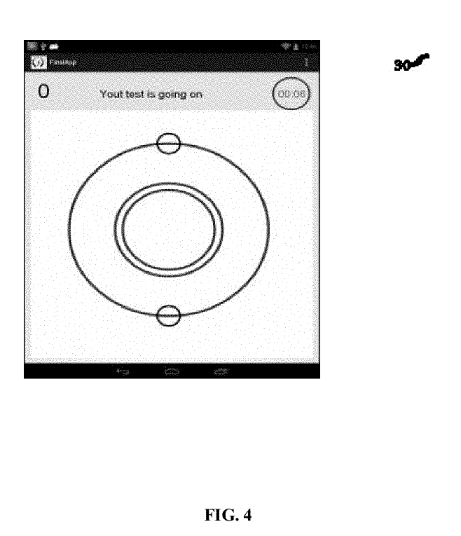

In a “Resize” test scenario as shown in FIG. 4, two inner circles and an outer circle are provided. In this test scenario, the user has to precisely move his/her fingers to resize the outer circle inside the two inner circles. The task is completed only after the user lifts his/her finger after resizing the outer circle. The processing module includes an instruction to evaluate the resize as “correct” if and only if the outer circle is in-between the inner circles when the candidate lifts his/her fingers. The instruction is based on the benchmark provided in the predictive model for evaluation. The candidate is scored on the basis of the correct resizes he/she has done in the allotted time and the score is measure of accuracy of finger dexterity.

“Fit” and “Resize” are automated applications delivered on a touch based communication device, and timing information is recorded using an automated timer provided through the application. These automated test helps in eliminating the subjectivity of grading associated with human. The test scenarios when combined, i.e. when the scores of the test scenarios are combined, the speed and accuracy trait for the finger dexterity of the user is available.

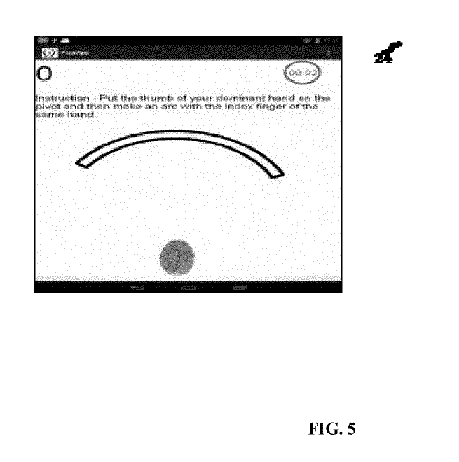

In another test scenario, the user is instructed via the user interface to perform the task via his/her dominant hand as shown in FIG. 5, and the accuracy of the rotatory movements of the wrist-finger assembly is measured. A thumb icon is shown at the bottom of the user interface screen on which the user has to place the thumb of his/her dominant hand. An arc in the form of the tunnel is shown on the screen. Once the thumb is pivoted on the required position, the candidate is instructed to draw an arc in-between the arc tunnel shown on the screen. If the thumb is not put in the required position the user is not allowed to draw the arc. The user has to accurately make arcs within the tunnel. In another example, the user has to make three arcs after which the position and the size of the arc changes. Again, the user has to make three more arcs for the changed tunnel. A specific time is allotted for the whole task to each user. The precise rotation of the wrist and the finger movements are measured with this test scenario. The user is scored on the basis of the number of arcs he/she makes. The application measures only the speed with which the candidate can rotate his/her wrist and fingers to draw an arc.

In another embodiment, the user can be additionally asked to place the fingers of the other hand on the touch screen at specified places to ensure that the test is always being taken as instructed with only a single hand. The touch interface measures and records all the possible information/data required for the scoring of the candidate's test. The interface records the X and Y co-ordinates of the index finger which is used to make the arc along with their time stamps. The application simulates the coordinated rotation of the wrist and finger of the candidate to perform tasks such as tightening of screws etc.

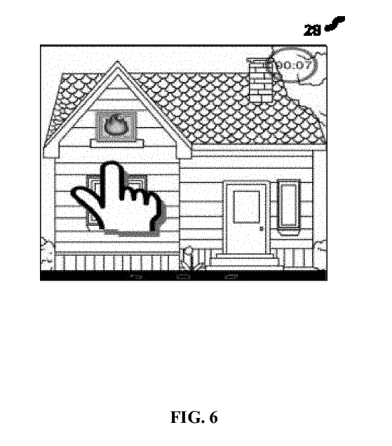

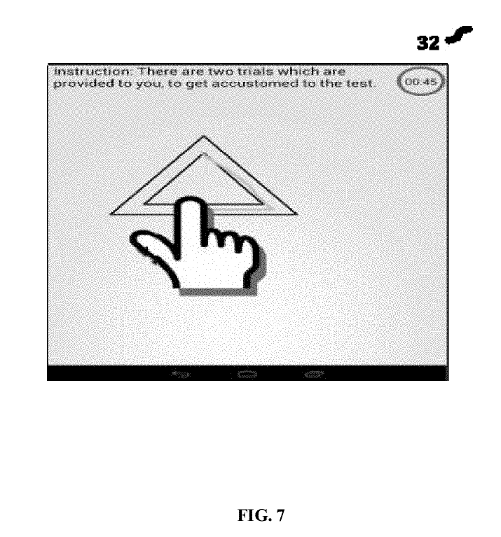

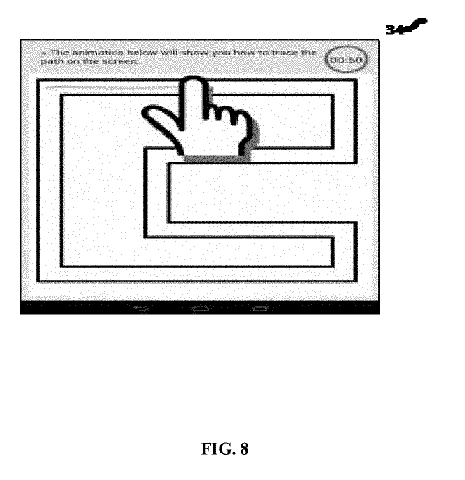

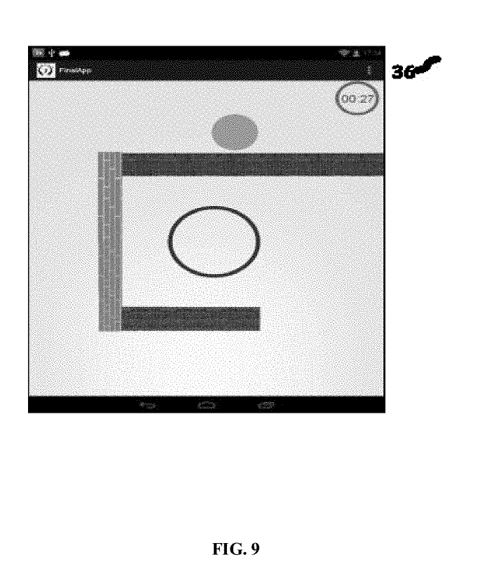

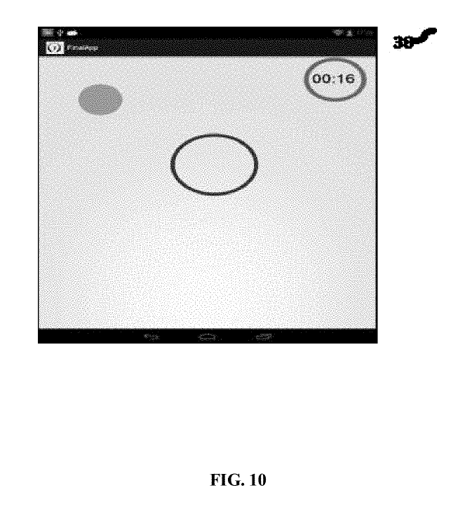

FIG. 6 is a diagrammatic representation of a test scenario where the user has to select the fire sign and the movement measures the speed of the action, and the fire sign is displayed at different locations and speed and accuracy of selection is measured. FIG. 7 and FIG. 8 are the diagrammatic representation of test scenarios where the user has to trace inside the given patterns, the precision of tracing, time of completion, and speed are measured; FIG. 9 and FIG. 10 are diagrammatic representations of test scenarios where the user has to roll the ball inside the circle, which is accomplished by the coordination of two arms, and the rolling speed and placement accuracy are measured.

The above test scenarios are few exemplary embodiments of tasks the user is assigned to measure motor skills related traits. Other such test scenarios and tasks can similarly be designed to match specific real world requirements.

Some criterion validity studies have also been performed, which establishes the validity of the tool as a predictor of job performance. The users took tests on the application while their job performance rating was collected from their managers. The correlation between the manager ratings and the application's scores was in the range of 0.19-0.38. The studies were done on tailors, machinists, grinders and machine operators.

The described embodiments may be implemented as a system, method, apparatus or article of manufacture using standard programming or engineering techniques related to software, firmware, hardware, or any combination thereof. The described operations may be implemented as code maintained in a non transitory “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” is a non transitory article of manufacture, comprises computer readable medium, hardware logic, or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

A computer program code for carrying out operations or functions or logic or algorithms for aspects of the present invention may be written in any combination of one or more programming languages which are either already in use or may be developed in future. The different modules referred herein may use a data storage unit or data storage device that is selected from a set of but not limited to USB flash drive (pen drive), memory card, optical data storage discs, hard disk drive, magnetic disk, magnetic tape data storage device, data server and molecular memory.

A computer network may be used for allowing interaction between two or more communication devices, electronic devices or modules, and includes any form of inter/intra enterprise environment such as the world wide web, Local Area Network (LAN), Wide Area Network (WAN), Storage Area Network (SAN) or any form of Intranet.

While only certain features of the invention have been illustrated and described herein, many modifications and changes will occur to those skilled in the art. It is, therefore, to be understood that the appended claims are intended to cover all such modifications and changes as fall within the true spirit of the invention.

I/We claim:

1. A method for measuring a plurality of traits associated with motor skills of a user, and providing a score based on the plurality of traits, wherein the method is implemented on a non-transitory computer readable medium, the method comprising:
generating a model comprising a benchmark to score each of the plurality of traits, wherein the plurality of traits comprise at least one of finger dexterity, speed of execution, finger and thumb co-ordination, wrist rotation, hand-eye co-ordination, hand steadiness, reaction time, accuracy of action, coordination between two arms to accomplish different tasks from each hand;
configuring a plurality of test scenarios delivered on a touch based user interface having a communication interface with a processing device;
measuring one or more of the plurality of traits based on user activity with the test scenarios, wherein the user activity comprising at least one of movement of at least one finger along a predefined pattern in one or more trajectories, simultaneous movement of at least one finger and thumb, and movement of at least one finger when thumb is pivoted;
comparing the measurements with the corresponding measurements in the model;
generating at least one of, one or more scores, and feedback analytics for the one or more plurality of traits based on the comparison; and
reporting the one or more scores to at least one of the touch based user interface and an external device.

2. The method of claim 1 wherein the one or more trajectories comprise a trajectory along an arc of a circle.

3. The method of claim 1 wherein the one or more trajectories comprise a trajectory within a tunnel shape.

4. The method of claim 1 wherein the measurement commences with the start of movement of user activity on the touch based user interface.

5. The method of claim 1 wherein the test scenarios comprises one or more of pre-defined patterns, pre-defined shapes, test instructions, demonstration samples.

6. The method of claim 1 wherein the test scenario comprises a placeholder position for at least one of a thumb or at least one finger.

7. The method of claim 1 wherein the measurements comprise position co-ordinates for at least one of a finger and a thumb, and a time stamp for the position co-ordinates.

8. The method of claim 1 wherein the one or more scores are communicated to a communication device as input data for a job fitment determination, and wherein the model is further used to determine motor skill scores for job fitment determination using the measurements of one or more of the plurality of traits.

9. A system for measuring a plurality of traits associated with motor skills of a user, and providing a score based on the plurality of traits, wherein the system is implemented using a non-transitory computer readable medium, the system comprising:
a predictive model comprising a benchmark to score each of the plurality of traits, wherein the plurality of traits comprise at least one of finger dexterity, speed of execution, finger and thumb co-ordination, wrist rotation, hand-eye co-ordination, hand steadiness, reaction time, accuracy of action to predict various scores that mimic scores to complete tasks in the 3-d world;
a test module comprising a plurality of test scenarios to test one or more of the plurality of traits;
a touch based user interface for providing the test scenarios for user activity, wherein the user activity comprises at least one of movement of at least one finger along a predefined pattern in one or more trajectories, simultaneous movement of at least one finger and thumb, and movement of at least one finger when thumb is pivoted;
a processing module for receiving data representative of the user activity, for measuring one or more of the plurality of traits based on the user activity with the test scenarios, for comparing the measurements with the corresponding measurements in the predictive model, and for generating at least one of, one or more scores, and feedback analytics for the one or more plurality of traits based on the comparison; and
a reporting module to receive and communicate at least one of, one or more scores, and feedback analytics for the one or more plurality of traits to at least one of the touch based user interface and an external device.

10. The system of claim 9 wherein one or more of the predictive model, the test module, the processing module, and the reporting module are configured on a server.
